(19) United States
(12) Patent Application Publication
(10) Pub. No.: US 2018/0009002 A1
(43) Pub. Date: Jan. 11, 2018

(54) METHOD FOR REDUCING THE WINDING LEVEL ADHESIVENESS OF AN ADHESIVE TAPE ROLL

(71) Applicant: TESA SE, Norderstedt (DE)

(72) Inventors: Manuel BENDEICH, Hamburg (DE); Marcel HÄHNEL, Klein Nordende (DE); Arne KOOPS, Neu-Lankau (DE)

(21) Appl. No.: 15/552,161

(22) PCT Filed: Feb. 22, 2016
(86) PCT No.: PCT/EP2016/053651

§ 371 Date: Aug. 18, 2017

(30) Foreign Application Priority Data
Feb. 20, 2015 (DE) 10 2015 203 088.1

(51) Int. Cl. B05D 1/00; B29C 63/02; B05D 5/08; C09J 7/02; B05D 7/04

(52) U.S. Cl. CPC B05D 1/62; C09J 7/0228; B05D 7/04; B05D 5/08; B29C 63/02; C09J 2423/106; C09J 2483/005

(57) ABSTRACT

The invention relates to a method for reducing end face stickiness of a roll (1) of adhesive tape, by supplying a precursor (18) to a plasma stream (20), using the plasma stream (20) enriched with the precursor (18) to coat a carrier film (2) with a passivation coat (3) in a plasma process, placing a carrier film section (5) by its passivation-coated side onto an end face (4) of the roll (1) of adhesive tape, removing the carrier film section (5) and leaving at least part of the passivation coat (6) on the end face (4) and reducing its end face stickiness.

This application is a §371 U.S. National stage of PCT International Patent Application No. PCT/EP2016/053651, filed Feb. 22, 2016, which claims foreign priority benefit of German Patent Application No. DE 10 2015 203 088.1, filed Feb. 20, 2015, the disclosures of each of which patent applications are incorporated herein by reference.

The invention relates to a method for reducing the end face stickiness of a roll of adhesive tape.

The production of pressure-sensitive adhesive tapes frequently sees substrate webs being coated with adhesives, the substrate webs having widths of 500 mm-200 mm. After coating has taken place, the wide adhesive tape rolls are slit into rolls of adhesive tape of desired working width. As a result of the slitting operation, the pressure-sensitive adhesives are exposed at the slit edges of the rolls of adhesive tape. The entire end face of the roll of adhesive tape may have adhesive properties, which make it more difficult or even impossible for further processing to take place and also for the product to be deployed.

These drawbacks occur especially when the adhesive tape has a coating of pressure-sensitive adhesive that is thick in relation to the substrate web. In the case of these so-called thick-layer products, in particular, it is also often the case that viscoelastic substrate webs with their own adhesive properties are used, and so the entire end face of the roll of adhesive tape is adhesive across virtually the entire slit area. As a result of the tackiness of the roll end face, contact with other objects causes the roll of adhesive tape to be destroyed or deformed on removal, and means it can no longer be deployed for further use. This drawback is particularly pronounced in the case of very narrow rolls of adhesive tape, referred to as narrow rolls.

Furthermore, an exposed and adhesive roll end face is subject to a high risk of soiling, particularly if dirt and dust are present in the immediate environment. For certain applications, the soiled adhesive tapes cannot be used, especially in the case of transparent bonds in the electronics sector. It is known practice to place siliconized or releasing papers or films onto the side faces. These releasing films or papers are diecut to the size of the end face, in appropriate shape and size. This, however, is very costly and inconvenient. Furthermore, the siliconized release disks have to be removed again before the roll of adhesive tape is used, and have to be replaced again after service, thus making the utilization of the roll of adhesive tape extremely inefficient. On automated processing of the roll, the release disks have to be removed and put into a suitable holder, without the roll undergoing soiling or sticking to other components in the course of unwinding.

Another alternative customary within the industry is the powdering of the end faces with individual pigments, such as talc, for example. With this method, however, there is significant soiling of the entire roll of adhesive tape, since the powdering is accomplished via atomization of the pigments. Furthermore, the small pigments “soak” into the adhesive compound, and so the effect subsides significantly after treatment. There are also changes in the optical properties of the adhesive tape, since the light is diffusely refracted at the slit edge. This is a drawback particularly for display bonds with high visual transparency properties.

WO 2008 09 565 3 describes a method for passivating an edge of pressure-sensitive adhesive tapes, in which the passivation is accomplished by physical or chemical crosslinking of the pressure-sensitive adhesive on the edge or by the physical or chemical breakdown of those structures in the pressure-sensitive adhesive that are responsible for the adhesive effect. This is achieved by applying a crosslinker to the side edge, with subsequent UV or IR irradiation, electron irradiation, gamma irradiation or plasma treatment. Crosslinkers disclosed include epoxides, amines, isocyanates, peroxides, or polyfunctional silanes. A drawback is the relatively awkward and inconvenient structure of the method.

EP 1 373 423 describes a method for deactivating the adhesive layer of the edge face of a roll of adhesive tape, by applying radiation-crosslinkable acrylates, acrylate oligomers, and acrylate prepolymers, and carrying out curing with ionizing and electromagnetic radiation.

US 2010/004 47 530 describes a method for coating the side edges of a roll of adhesive tape, using an indirect application process, in which radiation-curable coating materials or hot-melting polymers are employed.

EP 11 29 791 A2 describes a method for producing antiadhesive coatings wherein the antiadhesive layer is applied by low-pressure plasma polymerization to the material in web form, this material in web form being drawn continuously through a plasma zone which hosts a low-pressure plasma. The antiadhesive coatings, shaped by means of plasma polymerization, are produced in particular for reverse sides of adhesive tape and for release materials.

The methods identified above are of only limited suitability for reducing the tackiness of the end face of a roll of adhesive tape.

It is therefore an object of the invention to provide an improved method that reduces the tackiness of the end face of a roll of adhesive tape.

The object is achieved by means of a method as specified at the outset and having the features as described herein.

The method makes use of a plasma jet, by supplying a precursor to a plasma stream generated in the plasma jet, and using the plasma enriched with the precursor to coat a carrier film with a passivation coat in a plasma process. A carrier film section is placed by a passivation-coated side onto an end face of the roll of adhesive tape, the carrier film section is removed, and at least part of the passivation coat remains on the roll end face and reduces its stickiness. The method steps stated are preferably performed in the order listed.

The carrier film section is cut off from the carrier film after having been plasma-coated. In this way, a multiplicity of in-register passivation-coated carrier film sections can be produced by simple production technology.

The method of the invention makes use of the concept of not lowering directly the tackiness of the roll end face, but instead first providing a carrier film having a passivation coat, the passivation coat having been produced in a plasma process. In the plasma process it was possible, favorably, for particularly thin and homogeneous passivation coats to be produced with high levels of reproducibility. Depending on the choice of the materials for the carrier film and for the precursor, the ease of detachment of the passivation coats from the carrier film is different. In accordance with the invention, the carrier film is placed with its passivation coat onto the sticky roll end face, and at least part of the passivation coat is detached by the pressure-sensitive adhesive present on the roll end face, and joins to the pressure-sensitive adhesive. The peel adhesion between the pressure-sensitive adhesive and the passivation coat is greater than the peel adhesion between the carrier film and the passivation coat, and so, following detachment of the carrier film section, at least part of the passivation coat remains on the roll end face. The roll end face stickiness is reduced by that part of the passivation coat that has detached from the carrier film section.

In the method of the invention, the precursor is supplied to the plasma, in other words after the process gas has been excited to a plasma by the plasma jet. It is only the plasma stream which is enriched with the precursor and then directed at a surface of the carrier film.

As a result, the precursor is not exposed to the strong alternating electromagnetic field of an electrode tip of the plasma jet, or to the heat which is typically formed in the case of electric arclike discharges, or to any other field of excitation of the plasma jet that might possibly destroy the monomers of the precursor. Moreover, the soiling of the electrodes is prevented by this means.

There are various possibilities for supplying the precursor to the plasma.

With preference a liquid precursor is vaporized in a precursor unit and then supplied to a carrier gas; the carrier gas enriched with the precursor is subsequently supplied to the plasma stream.

The precursor may advantageously also be supplied as an aerosol to the plasma stream. Preference is given to the use of siloxanes or siloxane-containing compounds as precursors; in particular, HMDSO (hexamethyldisiloxane) is the precursor of choice. The carrier film is advantageously provided with a passivation coat 10 nm to 600 nm thick. The plasma process therefore ensures that a particularly thin passivation coat is produced, which on the one hand, by virtue of its thin nature, does not alter the functional properties of the rolls of adhesive tape after their transfer, and, on the other hand, is readily detachable from the carrier film and is therefore transmitted to the sticky plies of the roll.

The carrier film is preferably pressed with a laminating roller or similar device onto the roll end face. This produces a relatively strong adhesive bond between the passivation coat, or transferred parts of the passivation coat, and the roll end face, and so, after the carrier film has been removed from the roll end face, at least part of the passivation coat remains on the sticky regions of the roll end face and reduces its tackiness. The passivation coat is advantageously transferred only at the and onto the adhesive plies of the roll.

Through the method of the invention, the passivation coat is not produced directly on the roll end face, but instead initially on the carrier film, a fact which allows the method to be made more robust and more efficient.

The roll of adhesive tape is produced preferably by slitting of a wide adhesive tape roll. The roll of adhesive tape is slit off from the wide adhesive tape roll. The method of the invention is then applied to the slit-off roll of adhesive tape; advantageously, in order to save time, the slitting of the wide adhesive tape roll and the plasma-coating of the carrier film can take place at the same time. For the carrier film, preferably, a material from the group of PET, PVC, PC, PP, or PE is selected. These plastics are inexpensive and readily available.

With particular preference an apolar polymer is selected as material of the carrier film, since apolar polymers, especially with siloxane-containing passivation coats, form only a weak bond, and the passivation coat is therefore more readily partable from the carrier film.

The invention is described with reference to a working example in four figures, in which:

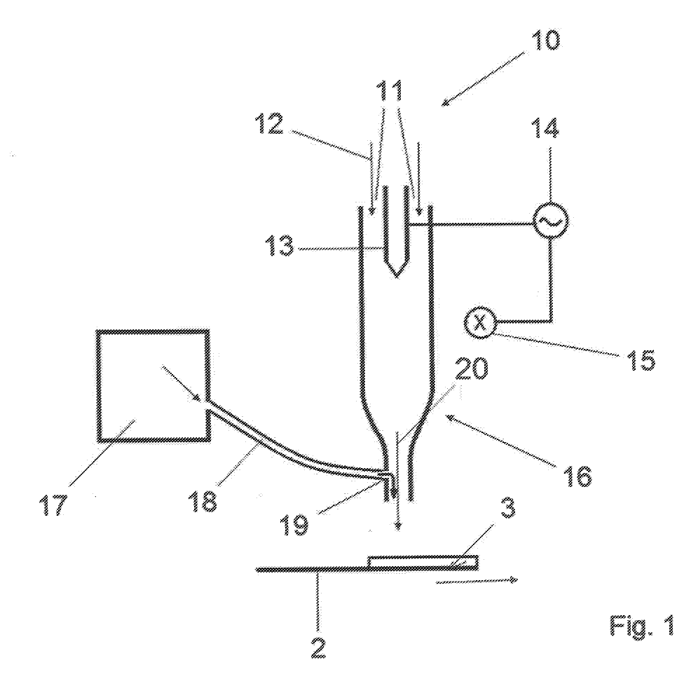

FIG. 1 shows a plasma jet for applying a passivation coat to a carrier film,

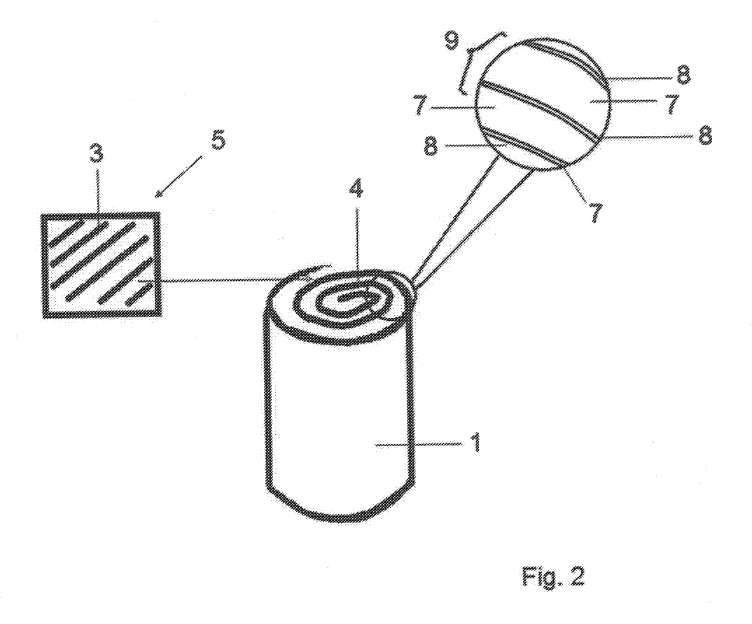

FIG. 2 shows a carrier film provided with the passivation coat, and a roll of adhesive tape with sticky roll end face,

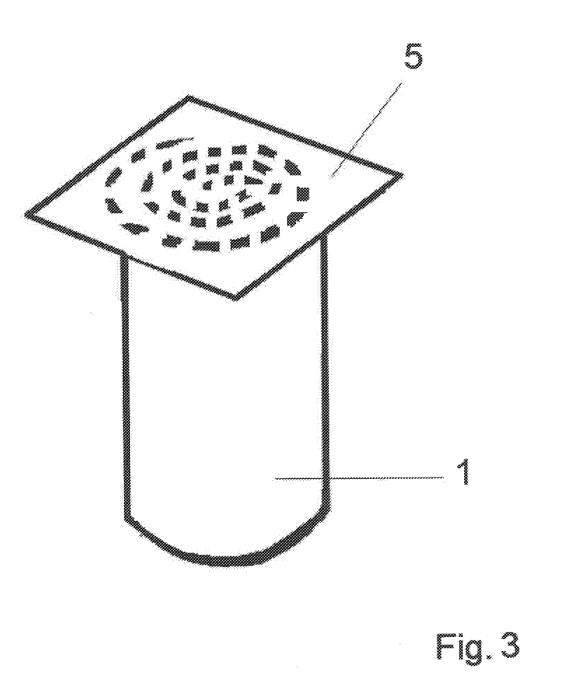

FIG. 3 shows a carrier film pressed onto the roll end face, in accordance with FIG. 1, and

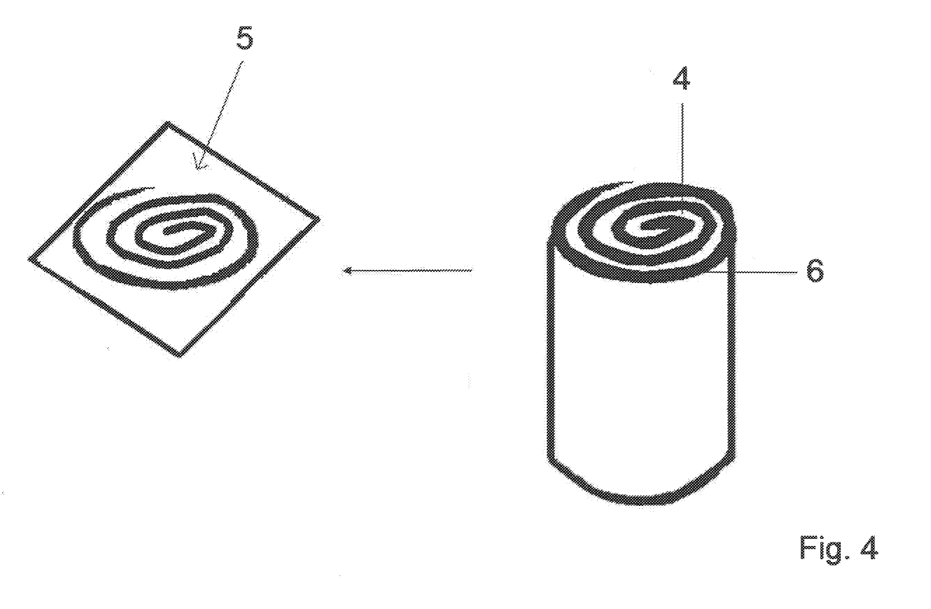

FIG. 4 shows a carrier film removed again from the end face of the roll of adhesive tape.

The method of the invention for reducing end face stickiness of a roll 1 of adhesive tape is based on first fabricating a carrier film 2 having a passivation coat 3 by means of a plasma jet 10 which is shown in FIG. 1. Thereafter the carrier film 2 provided with the passivation coat 3 is cut into carrier film sections 5 and applied by the coated side to a sticky end face 4 of the roll 1 of adhesive tape in accordance with FIG. 2.

In accordance with FIG. 3, the carrier film section 5 is pressed onto the roll end face 4. This can be done using a laminating roller (not shown). In this operation, the passivation coat 3 enters into close pressure contact with the sticky roll end face 4. As a result of the applied pressure and the contact of the passivation coat 3 with the sticky roll end face 4, a part of the passivation coat 6 joins to the edges of a pressure-sensitive adhesive web 8 that are responsible for the tackiness of the roll end face 4, and, after the carrier film section 5 has been removed, the part of the passivation coat 6 detached from the carrier film section 5 remains on the roll end face 4 and lowers the tackiness of the roll end face 4 in FIG. 4.

The roll end face 4 here refers to the two end-face sides of the rolled-up roll 1 of adhesive tape. The roll 1 of adhesive tape has a substrate web 7 and has the pressure-sensitive adhesive web 8 applied to one side of the substrate web 7. The substrate web 7 may be a film, a fabric or paper.

The roll 1 of adhesive tape shown in FIGS. 2 and 3 has the substrate web 7, which is coated on one side with pressure-sensitive adhesive. The pressure-sensitive adhesive forms the pressure-sensitive adhesive web 8 which fully covers one side of the substrate web 7. Substrate web 7 and pressure-sensitive adhesive web 8 form an adhesive tape 9. The substrate web 7 is fabricated and provided in widths of 500 mm-2000 mm and is also coated in this width with the pressure-sensitive adhesive. The substrate web 7 is wound up with the pressure-sensitive adhesive web 8, and so the roll 1 of adhesive tape likewise has a width of 500 mm-2000 mm. Only thereafter is the very wide adhesive tape roll slit into rolls 1 of adhesive tape having the desired working width. After the slitting operation, the pressure-sensitive adhesive is exposed at the slit edges of the rolls 1 of adhesive tape, more particularly of the pressure-sensitive adhesive webs 8, and its adhesive properties may make it difficult or even impossible for further processing to take place and for the product to be deployed.

The substantially circular end-face side of the roll 1 of adhesive tape, shown in FIG. 2, is referred to here as roll end face 4, and is distinguished by an alternating sequence of substrate web 7 and pressure-sensitive adhesive web 8.

In other embodiments of the roll 1 of adhesive tape, the adhesive tape 9 has a very small ratio of a thickness of the substrate web 7 to a thickness of the pressure-sensitive adhesive web 8. With adhesive tapes 9 of this kind, which are referred to as thick-layer products, it is common to use viscoelastic materials for the substrate webs 7 with their own adhesive properties, and so the entire end face 4 of the roll 1 of adhesive tape is adhesive.

As a result of the tackiness of the roll end face 4, after contact with other objects, the roll 1 of adhesive tape on removal is destroyed or deformed and can no longer be deployed for use. This is a problem in particular with narrow rolls, which have only a low mechanical strength.

The tackiness of the roll end face 4 is reduced by application of a part of the passivation coat 6. For this purpose, in a first method step in accordance with FIG. 1, a carrier film 2 is coated with a passivation coat 3 in a plasma process by means of the plasma jet 10. The plasma jet 10, which is shown diagrammatically in FIG. 1, has at least one inlet 11 for a process gas 12. The process gas 12 is air or nitrogen or a mixture thereof, and is conveyed past an electrode tip 13. The electrode tip 13 is connected to a high-frequency alternating voltage 14 of several kV with a frequency of about 10 kHz. Between the electrode tip 13 and a counterelectrode 15, a strong alternating electrical field is produced that leads to what is called a corona discharge, which ionizes the process gas 12 flowing past the electrode tip 13 through the plasma jet 10 and converts it into a plasma stream 20. The plasma stream 20 is guided through a plasma nozzle 16, to which a precursor unit 17 is connected via a precursor nozzle 19. A vaporized precursor 18 is supplied to the plasma stream 20 from the precursor unit 17. In the present example, the precursor 18 is hexamethyldisiloxane (HMDSO), which is supplied to the process gas 12 at a rate of 40 g/hour. The precursor nozzle 19 stands at a perpendicular angle to the surface of the carrier film 2, and opens out into the plasma nozzle 16, with the carrier film 2 lying on a rotating table (not shown).

The treatment of a surface of the carrier film 2 takes place at or close to atmospheric pressure, although the pressure in the electrical discharge chamber of the plasma jet 10 or in the process gas channel may be higher. A plasma here refers to an atmospheric pressure plasma, which is an electrically activated, homogeneous, reactive gas which is not in thermal equilibrium, having a pressure close to the ambient pressure in an active region. Generally speaking, the pressure is 0.5 bar more than the ambient pressure. The electrical discharges and the ionization processes in the electrical field cause activation of the process gas, and highly excited states are generated in the gas constituents. The gas or gas mixture used is referred to as process gas 12. The precursor 18, in gas form or as an aerosol, is then supplied to the process gas 12 in the plasma nozzle 16, which is connected via a gas-conducting channel to the precursor unit 17, and it is this precursor 18 that forms the actual passivation coating 3 on the surface of the carrier film 3.

### EXAMPLE 1

In this example, hexamethyldisiloxane is supplied to the process gas and is excited in the process gas, significantly increasing its reactivity at the same time. As a result, the siloxane is accommodated optimally on the surface of the carrier film 2 and attaches firmly. In this example, a plasma polymerization layer is generated using the PlasmaPlus plasma technology of Plasmatreat GmbH.

The experimental system comprises the following parameters, conditions, and technical data:
Carrier film 1: siliconized BOPP
Plasmajet 10: Generator FG 5001 from Plasmatreat GmbH, fixed nozzle 216028WE
Precursor 18: Hexamethyldisiloxane (HMDSO);
Precursor quantity: 40 g/hour
Number of treatments: 1-3-fold
Treatment rate: 80 rpm for rotary table with the carrier film 2, corresponding to an application rate of 5 m/min of the plasma nozzle 16
Distance of plasma nozzle 16 from carrier film 2: 15 mm
PCT (Pulse Cycle Time): 100%

BOPP here stands for biaxially oriented Polypropylenes. PCT (Pulse Cycle Time) means that the plasma discharge is modulated by pulsing. The switching on and off may improve the service lives of the electrodes and influence the formation of the reactive species. In this case, operation takes place with continuous discharge.

After the plasma coating of the carrier film 2, the carrier film section 5 removed is laminated onto the end face 4 of the roll 1 of adhesive tape using a 4 kg roller and is immediately removed. On the carrier film section 5 removed, the complement of the transferred part of the passivation coat 6 is recognizable as a result of refraction of light. In the present example, for the tesa product ACXplus 7055, a significantly reduced peel adhesion on the roll end face 4 was found. The treated rolls 1 of adhesive tape no longer adhere by the end face 4 to smooth or metallic substrates, and can be picked up again without deformation.

### EXAMPLE 2

A second example uses the indirect plasma process PlasmaLine® from VITO, Belgium. This plasma treatment was developed for the finishing of plastics surfaces on the basis of the corona technology under atmospheric conditions. It constitutes a DBD (dielectric barrier discharge) system. One construction of the plasma nozzle is illustrated in “Atmospheric DBD plasma processes for production of lightweight composites” (Vangeneugden et al., 2013, 21^{st} International Symposium on Plasma Chemistry (ISPC 21), Sunday 4 Aug.-Friday 9 Aug. 2013, Cairns Convention Centre, Queensland, Australia).

Using a slotted nozzle, a linear atmospheric plasma is blown out via the process gas 12 onto the carrier film 2 to be treated, without the need for a counterelectrode 15. The introduction of reactive chemicals into the stream of process gas produces a thin, functional passivation coat 3, without altering the properties of the base material of the carrier film 2. The plasma stream 20 in the case of APTES is driven forward by its flow rate from the electrode tip 13 and after a short distance is guided onto the carrier film 2. With this process, the carrier film 2 coated was siliconized BOPP, and the parameters set were as follows:
Distance of nozzle from
BOPP for treatment: 3.5 mm
Speed: 5 m/min
Power: 2500 W
Process gas stream: 900 sl/min
Type of aerosol: APTES
Number of treatments: 5-times

APTES is 3-aminopropyltriethoxysilane. After the plasma treatment of the carrier film 2, the carrier film section 5 is laminated with a 4 kg roller onto the end face 4 of the roll 1 of adhesive tape and is immediately removed. The complement of the transferred part of the passivation coat 6—in the present case a plasma polymerization coat—can be seen on the removed section 5 of carrier film as a result of refraction of light. With the tesa® product ACXplus 7055, a significantly reduced peel adhesion of the roll end face 4 can be observed. The treated rolls 1 of adhesive tape no longer adhere by the roll end face 4 on a smooth or metallic substrate, and could be picked up again without deformation.

One class of monomers frequently used as a precursor in plasma processes are siloxanes. They consist of a skeleton of silicon and of oxygen atoms with a plurality of hydrocarbon radicals. Depending on the monomer parameters and plasma parameters used, it is possible to deposit quartzlike passivation coats 3 with a variable hydrocarbon fraction (SiOxCyHz).

Preference is given to the deposition of pure SiOx passivation coats 3, which can be produced in the form of thin, glasslike coats.

For the deposition of passivation coats, the following polyfunctional siloxanes are suitable: HMDSO (hexamethyldisiloxane); TEOS (tetraethoxysilane); PDMS (polydimethylsiloxane). In the case of the deposition of the frequently employed HMDSO as passivation coat, in the plasma, there is typically first elimination of hydrogen and of whole methyl groups, which react in the presence of oxygen to form water, CO, and CO₂. The Si-O-Si framework is usually retained as a building block for the quartzlike polymer layer as passivation coat 3.

As carrier films 2 it is possible in principle to utilize all polymeric films, including more particularly films of PET, PVC, PC, PP, or PE.

However, the anchorage to apolar polymers of a passivation coat 3 to be transferred is much less pronounced, and so the transfer of the passivation coat 3 to the roll end face 4 is easier. It has emerged as being advantageous, moreover, that siliconized carrier films 2 significantly enhance transfer and can be removed with less expenditure of force.

### List of Reference Numerals

1 roll of adhesive tape
2 carrier film
3 passivation coat
4 roll end face
5 carrier film section
6 detached part of passivation coat
7 substrate web
8 pressure-sensitive adhesive web
9 adhesive tape
10 plasma jet
11 inlet
12 process gas
13 electrode tip
14 alternating voltage
15 counterelectrode
16 plasma nozzle
17 precursor unit
18 precursor
19 precursor nozzle
20 plasma stream

1. A method for reducing end face stickiness of a roll of adhesive tape, comprising:
supplying a precursor to a plasma stream,
using the plasma stream enriched with the precursor to coat a carrier film with a passivation coat in a plasma process,
placing a carrier film section by its passivation-coated side onto an end face of the roll of adhesive tape, and
removing the carrier film section and leaving at least part of the passivation coat on the end face and reducing its end face stickiness.

2. The method as claimed in claim 1,
wherein the precursor is supplied to a plasma stream at a plasma nozzle, and
the plasma stream enriched with the precursor is directed at a surface of the carrier film.

3. The method as claimed in claim 1,
wherein a liquid precursor is vaporized and then supplied to a carrier gas.

4. The method as claimed in claim 1,
wherein siloxanes are used as precursor.

5. The method as claimed in claim 4,
wherein HMDSO is used as precursor.

6. The method as claimed in claim 1,
wherein the carrier film section is pressed with a laminating roller onto the end face.

7. The method as claimed in claim 1,
wherein the carrier film is provided with a passivation coat 10 nm to 600 nm thick.

8. The method as claimed in claim 1,
wherein a material selected from the group consisting of PET, PVC, PC, PP, and PE is selected for the carrier film.

9. The method as claimed in claim 1,
wherein an apolar polymer is selected as material of the carrier film.

10. The method as claimed in claim 1,
wherein the roll of adhesive tape is removed by slitting from a wide adhesive tape roll.

11. The method as claimed in claim 10,
wherein while the wide adhesive tape roll is being slit up into rolls of adhesive tape, the carrier film is being plasma-coated.
